(19) United States
(12) Patent Application Publication
(10) Pub. No.: US 2009/0288123 A1
(43) Pub. Date: Nov. 19, 2009

(54) Passenger tray convenience system

(76) Inventors: Ron G. Havlovick, Dallas, TX (US); Thomas Michael Emge, Melbourne, FL (US)

Correspondence Address: Ron G. Havlovick, Apt. 325, 18333 RoeHampton Drive, Dallas, TX, 75252, US

(21) Appl. No.: 12/152,162

(22) Filed: May 14, 2008

(51) Int. Cl. H04N 7/18; A47C 7/62; G08B 23/00

(52) U.S. Cl. 725/77; 297/217.3; 340/963

(57) ABSTRACT

An aircraft entertainment, gaming, internet, telephone, information, menu selection, ordering and purchasing system, video projection system, and seat occupied system providing pre-flight, in-flight, post-flight passenger entertainment, internet, information, menu selection, ordering and purchasing, via projected video or image, and a seat occupied system, integrated into an aircraft passenger seat tray. The aircraft passenger seat tray being an all in one convenience system for the aircraft passenger while allowing the normal use of the aircraft passenger seat tray for the resting and support of meal trays, drinks, business usage, etc.

### REFERENCES CITED

| | |
|---|---|
| Aircraft passenger entertainment system | Kline |
| U.S. Pat. No. 4,352,124 - Filed Oct. 27, 1978 - Bell & | |
| Howell Company | |
| Aircraft video projection system | Gradin |
| U.S. Pat. No. 4,639,106 - Filed Apr. 26, 1985 - Sundstrand | |
| Data Control, Inc. | |
| Amusement and information system for use on a | Harrison |
| passenger carrier | |
| U.S. Pat. No. 4,584,603 - Filed Oct. 19, 1984 | |
| Video game apparatus integral with airplane passenger | Greenwald |
| seat tray | |
| U.S. Pat. No. 4,630,821 - Filed Feb. 22, 1985 - Aero-Vision | |
| Systems, Inc. | |
| Multi-passenger vehicle catering and entertainment system | Jerome |
| U.S. Pat. No. 6,177,887 - Filed Jul. 6, 1999 | |
| Full color solid state laser projector system | Knize |
| U.S. Pat. No. 5,317,348 - Filed Dec. 1, 1992 | |
| Laser projection display system | Kurtz |
| U.S. Pat. No. 6,577,429 - Filed Jan. 15, 2002 - Eastman | |
| Kodak Company | |
| Rear screen video projection system for aircraft passenger | Gradin |
| entertainment | |
| U.S. Pat. No. 5,123,728 - Filed Mar. 18, 1991 - Sony Trans | |
| Com, Inc. | |
| Entertainment and data management system for passenger | Berry |
| vehicle including . . . | |
| U.S. Pat. No. 5,311,302 - Filed Jul. 2, 1992 - Hughes | |
| Aircraft Company | |

### FIELD OF INVENTION

The present invention relates in general to an aircraft entertainment, gaming, internet, telephone, information, menu selection, and ordering and purchasing system for providing both pre-flight, in-flight, post-flight passenger entertainment, internet, information, menu selection, ordering and purchasing, and a seat-occupied system via a self contained aircraft passenger seat tray video projection system. The integration of all these systems herein called a passenger convenience system within the passenger seat tray.

### BACKGROUND OF THE INVENTION

An airline operating the aircraft which would encompass such a convenience system has several requirements for installing this convenience system on board its aircraft. First, the airline wishes to maximize its profits by offering the passenger a desired service or feature for which the passenger is willing to pay. This desired service or feature offered to the passenger enhances his or her flight experience and simultaneously enhances the airline's revenue. Second, the airline wishes to ensure the passenger receives maximum service for the class in which he or she is flying. Third, the airline has to ensure the safety of the passenger and requires that the system does not interfere with on board avionics. Fourth, the airline must ensure the power of such a system does not create a heat or thermal problem within the aircraft and distract from the comfort of the passenger. Fifth, the airline must ensure the power with regards to fuel usage is not excessive and that the profits gained by passenger usage of the system is not offset by the increased fuel use in creating the power necessary to operate the system. Sixth, the system itself cannot add or detract from the spaciousness of the aircraft and therefore the comfort of the passenger. Seventh, the system in itself has to be user friendly and not cumbersome to use or require explanation. The flight attendant cannot be burdened more so by the presence of the system on the aircraft. Eighth, the system must add to the passenger's perception of the airline such that by the nature of the system the passenger leaves the aircraft of the respective airline with a greater sense of satisfaction. If the airline passenger is effectively happier when he or she leaves as compared to when he or she boarded, the airline may well ensure a repeat passenger. Ninth, the system must offer to the airline more than just a return on investment. The system must give the airline a greater insight into the passenger by retaining the passenger's selections and therefore provide the ability for the airline to anticipate his or her needs and wants on the passenger's next trips. Tenth, the system must offer to the airline a serviceability that precludes invasion into the aircraft body in order to repair, upgrade, or replace a defective unit. By dispersing the complexity of the system throughout many individual units the airline lessens downtime and enhances the upgradeability, replacement or retrofit capability of the system. Eleventh, the system must have commonality amongst all its aircraft. To have one aircraft system configured in one way and another aircraft system configured in another way adds to complexity and a potential long term service cost. Twelfth, the system must be reliable to withstand shock, vibration, and stand the rigors of many years and miles of aircraft use. Last, the system must be controllable from a single source, or operator. Though reliability is enhanced by dispersing the components to many smaller or sub-systems, software and the like must be up-gradable from a common point or central control.

The invention described herein is the basis to conquer all known maladies of existent systems and incorporate new features to address all of the above requirements of the airline with respect to the aircraft containing the passenger convenience system.

In modern day aircraft, the use of laptop computers, portable gaming devices, and back of seat LCD systems are widely known. In fact, the latest aircraft of today have pre-flight and in-flight information systems, video systems, gaming systems, telephone, and order and purchase systems using a back of the seat LCD or systems that fold out from within the armrest. These may include wire bound or wireless remote controllers within the arm rest of the passenger seat or seat-back of the forward seat

With these known previous aircraft entertainment systems, they comprise the 2 parts, the display, being a LCD, TV, or an over head or rear projector, and a passenger remote controller, located within the arm rest of the passenger seat or within the seat-back of the forward seat. In some non-gaming or non-passenger interactive systems, the back of the seat LCD is a touch-sensitive screen. In this case, there is no remote controller. However, the gaming or inter-activity of such a system is precluded. In all known art, there is no integral single apparatus which operates as an entertainment, internet, telephone, information, menu selection, and ordering and purchasing system.

Furthermore, of all known art, the systems themselves are not self contained. These systems require a separate apparatus for holding the display, or the projector, and another apparatus for holding the controller, be it an arm rest or seat-back of the forward seat. In some cases, the seat tray is used, but is required to be flipped over for non-convenience system use, or the controls are within the rear of the forward seat making the passenger reach to gain access to those controls, or the flight attendant is burdened with handing out and retrieving game or the like controllers to or from the passenger.

Furthermore, in prior art, the entertainment, etc., system is an addition to the aircraft cabin or structure. A display is added or brackets are needed and the like. These items induce an increase in weight to the aircraft cabin instead of a mere replacement of an existing piece of the aircraft cabin.

In the case of an over head projector, mounting brackets and the like must be added in order to hold the projector. In the case of a fold up or down display, the motor and fold out brackets have to be added to hold or power the LCD up and down. In the case of a rear seat LCD, the seat itself is special in order to hold and acquire power for the LCD.

There is no system today, under any name, be it entertainment system, projection system, or the like that incorporates all display, control, entertainment and the like electronics, in one integral unit.

Within these prior art systems there are 2 operative types. One type is cabled from the passenger remote controller to a central control unit. The central control unit relays the information back to the passenger display. The other type is wireless, such that the passenger remote controller is wireless which transmits the passenger's selections to the central control unit which relays the information requested back to the passenger's display. In one case additional cables to communicate from the central controller to the passenger display are required. In the other case a wireless remote controller is offered to the passenger with the possibility the passenger may walk off with the controller. In this event, a tracking mechanism is needed within the remote controller to prevent the loss of the controller. This may cause an embarrassing situation requiring confronting the passenger who has inadvertently taken the remote controller.

Also within all these systems, the display electronics and the controller electronics are contained within 2 separate apparatuses. Therefore the service complexity of these prior systems is increased. Troubleshooting to determine the failed component whether display or controller is more difficult. In the event the flight attendant is informed of a defective display or controller, there is little the flight attendant can do. The passenger maybe re-seated. However in a fully occupied aircraft this may not be possible.

Further, most of the present systems have no way to exchange payment information for the items or services selected by the passenger. A simple credit, debit or courtesy card swipe, and the credit or debit system allowing for payment of the item(s) or service(s), are not included in these systems.

Still further, no present system contains the sensor(s) necessary to ascertain the relative position of the display to the passenger viewer. In some cases, the drop down display is at such an angle as to prevent the passenger from seeing the movie he or she wishes to view. Further, present systems do not allow passenger control of display brightness. One passenger may require a brighter screen than his or her neighbor. Present systems do not allow for this control.

Still further, most of these systems do not incorporate a sensor to indicate if the passenger is within his or her seat. Since the passenger's presence is unknown, the system for that seat must remain powered. Instead of conserving power, and hence fuel, by turning off power to the system when no passenger in the seat, the system must power all seats, occupied or not, all the time.

Still more, all the present systems do not contain themselves well for radio frequency (rf) or electromagnetic (em) interference. This is largely due to the large size of the display. Note that in large aircraft these displays could number 360 or more. The viewing area of the display has to be large and therefore rf and em interference with aircraft avionics is possible. This poses an in-flight safety concern as the display itself may cause interference with the aircraft avionics.

Last, for all these systems the cost is relatively high. The display or projector, the remote controller, and the cabling for the information exchange costs must be included in the overall expense of the system. In the case of a wireless remote, either the wireless remote controller has to have replaceable batteries, a flight attendant nightmare, or rechargeable batteries within the wireless remote controller increase the cost even higher.

In U.S. Pat. No. 4,352,124, “Aircraft Passenger Entertainment System”, and in U.S. Pat. No. 4,639,016, “Aircraft Video Projection System”, the display used is an overhead projector precluding individualized passenger enjoyment via selection of personal preferences.

In U.S. Pat. No. 4,630,821, “Video Game Apparatus Integral with Passenger Seat Tray”, it specifically calls out a TV display within the seat tray. This yields an odd angle to view a game system, such that the passenger sits upright having to look down to view the TV within the seat tray when extended. Within this patent, it shows the tray with the embodied TV display. A side view further represents this embodiment of the TV screen being an integral part of the passenger seat tray.

However, to control the game, the joystick is inserted into the seat tray. Again, all parts of the system are not integral to one unit.

Furthermore, the TV embedded within the hollow of the seat tray is cause for concern for the glass of the TV could potentially cause injury during a rough landing.

Still further, the safety concerns of the RF and EM hazards due to the excessive size of the TV screen itself.

As further noted in U.S. Pat. No. 4,630,821, “Video Game Apparatus Integral with Passenger Seat Tray”, claims the game is rendered via internal memory from which the airline attendant may change from time to time.

Furthermore, U.S. Pat. No. 4,630,821, “Video Game Apparatus Integral With Passenger Seat Tray”, does not elaborate as to how the exchange of information will be handled. No reference is made as to how this exchange is going to be accomplished or via what means. Is this a further burden to the flight attendant? In modern day aircraft this means 360 requests for a different program or game cartridge.

In U.S. Pat. No. 4,584,603, “Amusement And Information System For Use On A Passenger Carrier”, the device described employs three apparatus with regards to the rear of the forward seat. Again, the convenience system is not a single integral unit.

In U.S. Pat. No. 4,866,515, “Passenger Service And Entertainment System For Supplying Frequency-Multiplexed Video, Audio, and Television Game Software Signals To Passenger Seat Terminals”, shows an integral unit within the rear of the forward seat. For menu selection of services, one must reach forward in order to make such selections. Also, for game playing, the requirement to reach across the seat tray during a food service is impractical. Otherwise, a game controller must be issued to the passenger and the apparatus is then not integral to one unit. This invention does not lend practicality for all items of use within the convenience system.

In U.S. Pat. No. 6,177,887, “Multi-Passenger Vehicle Catering And Entertainment System”, in one embodiment, FIG. 4, the system is integral with the passenger seat tray. However, it specifically states that in order to use this system, the tray must be flipped over in order to gain access to the controls of the system. It further states that in order to use the passenger tray as a utility tray the tray must be flipped again to the opposite side. In other embodiments, the system is not integral to the passenger seat tray.

Does this mean during food service, which is customary within the aircraft cabin, the passenger must pause the game or movie, and flip the tray so a beverage or food can be served? If the game or movie has commenced, does the airline flight attendant really wish to have the passenger stop in the midst of his or her viewing pleasure in order to handle the beverage or food the passenger has ordered through the system itself? The idea is to enhance the passenger's experience by use of the system, not inconvenience them by their use of the system during food or beverage service.

Furthermore, U.S. Pat. No. 6,177,887, “Multi-Passenger Vehicle Catering And Entertainment System”, indicates a multiplexer/de-multiplexer and modulator/demodulator as the means by which the central computer communicates to the seat computer. This is unnecessary since use of Ethernet and dynamic or virtual addressing is well known in the art. In effect, each seat tray has its own electronic address and the same Ethernet cable is routed to all seat trays. The means by which this is accomplished is shown within this patent and in the invention herein.

In U.S. Pat. No. 5,311,302, “Entertainment and Data Management System For Passenger Vehicle Including Individual Seat Interactive Video Terminals”, the device is not interactive with respect to gaming. Shown in FIG. 2, is the gaming port. The passenger must then gain an additional unit or apparatus and plug this additional unit into the Video Terminal for gaming interactivity. A touch-sensitive screen mounted in the rear of the forward seat or via arm rest fold out does not allow for ease of use by the passenger for two handed gaming control.

The object of the present invention is to provide a passenger convenience system, composing entertainment, gaming, internet, telephone, information, menu selection, ordering, purchasing, and a seat-occupied system, contained exclusively in the aircraft passenger seat tray. To accomplish this, the display is accomplished through a projection device and not through an LCD or TV display. In the preferred embodiment, the projection device is a laser projector. However, other embodiments using LED, LCD, or other type of projection systems are not precluded. The electronics, similar to a laptop computer, are contained solely within the hollow of the aircraft passenger seat tray. In this regards, all criteria for the passenger convenience system is contained within one apparatus, the passenger seat tray.

Note, in the present invention, no new items are added for the convenience system. The normal seat tray is removed and the new passenger seat tray containing the convenience system is inserted. This allows retrofit-ability to existing aircraft, as well as for installation in new aircraft. Also, in the case of an in-flight convenience system passenger seat tray malfunction, the flight attendant or mechanic simply extracts the seat tray, and inserts the replacement. A potentially un-serviced passenger is eliminated. No seat reassignment or flight attendant apology is necessary.

Also, within the invention as will be described, movie, game, telephone, internet, menu, order and purchase exchange information is obtained via wireless, or optical or electrical Ethernet cable.

Finally, the convenience system employs all components necessary to improve profits to the airline operating that aircraft. Games, movies, telephone, internet time, drink and food selections, and purchases are all paid for via credit or debit card. (A courtesy card issued by the airlines or operator of the aircraft is also considered herein.) The flight attendant no longer carries cash or needs to find change, or what have you, compatible with the multiple countries in which the aircraft may operate. The pay to play or view ideology is incorporated on a per passenger basis. Further, marketing data and passenger information is obtained through the selections he or she makes. Hence, improved products and services may be offered by knowing the passenger's selections history. Last, since the demographics of passengers are global, language selection is based on the passenger, and not upon the origin or destination of the aircraft.

### SUMMARY OF THE INVENTION

The invention described herein contains a projection display system. The projection display system may be an LED, LCD, Optical, bulb, or in the preferred embodiment, a laser projector. Using the preferred embodiment, the laser(s) deflects off a mirror, a digital light projector (DLP), at a specific scan rate and the light impinges onto the rear of the forward seat. The use of DLP for light reflection is well known in the art.

Furthermore this projection display system encompasses an automatic focus system which is well known in the art. A screen distance sensor being an ultrasonic, reflective light, or reflective laser or the like can be used to determine distance from the passenger seat tray to the seat-back of the forward seat. Since reclining of the forward seat may induce an angular display, the distance sensor determines this angle and focus-adjusts accordingly to prevent display distortion. It also increases or decreases light intensity to maintain a constant apparent brilliance of the projected display. (The light hitting the upper portion of the reclined seat would be nearer and hence more intense than the lower portion of the seat. Knowing the distance, the light luminance or intensity is maintained across the projected display.)

Still further, the projection display system encompasses light reflection sensors, which are well known in the art. The use of photo diodes to determine reflected light intensity is well known. Due to the fabric the airline maybe using for the back of the forward seat, the projected display may not be bright enough for the passenger to view. Light reflection sensors establish a luminance baseline. Therefore, if the passenger chooses to increase the luminance of the projected display, the passenger is increasing the luminance from a known level.

Still further, the projection display system encompasses light reflection wavelength sensors, which are well known in the art. The use of photo diode(s), spectrum grating(s), or an interferometer to determine the wavelength of light, or color, is well known in the art. Due to the fabric the airline maybe using for the back of the forward seat, the projected display could distort colors based on the color of this fabric. Since color is a direct function of wavelength, sensors receive the reflected display (reflected wavelength, in effect color) and compensate the projected display to accommodate this fabric color. In effect, the projected display is compensated to ensure the color which is reflected from the back of the forward seat to the passenger, is the color intended by the projection display system.

Still further this projection display system encompasses an ambient or surrounding light detection sensor which is well known in the art. Either a photo-diode, photo-voltaic source, optical coupled light, or the like system are all well known methods to determine ambient or surrounding light. Adjacent passengers with overhead lights on or off, affect the light intensity necessary for the projected display to maintain a compensated luminance to allow a passenger's normal viewing.

Also, some passengers may wish a different luminance. This adjustment may be accomplished via the touch-tap pads, monitored by the general processor system, the passenger may select a different luminance level for his or her viewing.

Still further this projection display system encompasses proximity sensors which are well known in the art. The use of infra-red, laser reflection, ultrasonic, electric field displacement, frequency shifting, and the like for use of determining very close proximity is well known in the art. In the preferred embodiment, a small person or child could inadvertently place their head in front of the light beam(s) being used to transmit the image to the rear of the forward seat. No matter how unlikely this is, the projection display system monitors the forward proximity system and in the event it detects the presence of a human near the projected display aperture of the passenger seat tray, the projection display system mandates an immediate shut down of all projected light, which in the preferred embodiment is a laser projector.

Finally, this projection display system contains a motion, vibration, and tilt system which is well known in the art. Either tremble switches, piezo elements, vibration reeds, gyroscopes, frequency shifting or the like are all well known methods to determine movement or vibration. The movement or vibration must be known in that an aircraft is not a stationary platform. Many conditions cause the aircraft to jostle, move about or vibrate. In order for the projected display to stay stationary during these abrupt or slow movements the motion of the passenger seat tray must be known. Furthermore a tilt sensor provides information to the flight attendants to indicate the passenger seat tray is in its stowed or locked position. This is also an indicator to power down the passenger seat tray in order to conserve power whenever the passenger seat tray is in the stowed or locked position and hence is not being viewed or used.

The projection display system interacts with the general processor system, the communications system, the video system, the gaming system, the selection and purchasing system, touch-tap pad system and the passenger information system.

The invention described herein contains a gaming system. All controls for the gaming system are integral with the passenger seat tray. Touch-tap pads, as used within laptop computers, are well known in the art. The use of dual touch-tap pad controls allows for dual hand interactive game play. The gaming system can interact with the internet system or with other passengers on board the aircraft. The central control unit indicates which passengers have selected a game and alerts the passenger of who else on the aircraft may wish to commence interactive game play with him or her. Once the game is purchased, the passengers can become interactive game players amongst themselves or simply play against the game system itself. The central control unit controls the interactivity between the passenger game players. Multiple players playing the same game at the same time interactively is well known in game system art.

The gaming system interacts with the general processor system, the communications system, the projection display system, and the selection and purchasing system.

The invention described herein contains a video system for movies, TV programs or sitcoms or daytime dramas as distributed in cable or regular TV. Since the invention herein contains a selection system as well, the selection of which video program to view is at the option of the passenger.

The video system interacts with the general processor system, the communications system, the projection display system, and the selection and purchasing system.

The invention described herein contains a communications system. The reception and transmission of information to and from the central control unit can be from wireless antenna or Ethernet cable, either optical or electrical. The wireless antenna allows for reception and transmission of electronic signals, and is well known in the art. Bluetooth and the like are well known wireless reception transmission systems.

The communications system may also contain a fiber optic or electrical cable (Ethernet or the like) connection. The communications system allows for the reception and transmission of light or electrical signals down a serial fiber optic or Ethernet or the like cable. The reception and transmission of optical or electrical signals via a fiber optic cable or Ethernet cable are well known in the art. In the preferred embodiment, the use of an optical Ethernet cable would be used.

This communications system receives information for game or movie downloads, interactive passenger gaming, intra passenger or flight attendant communication to the passenger, information downloads, confirmation of meal or drink selection as well as purchase of goods or item confirmation. Also, the communications system transmits information for game or movie selection, interactive passenger gaming, intra passenger or passenger communication to the flight attendant, information uploads, or selection of meal or drink as well as purchase of goods or items.

The communications system interacts with the general processor system, the video system, the audio system, the projection display system, the touch-tap pad system, and the selection and purchasing system.

The invention herein contains a general processor system which is well known in the art. The general processor system is used for general overall control and passenger tray task management.

One of the tasks to be managed by the general processor system is power up and down sequencing to control which system is or needs to be active in order to save power.

Another task of the general processor system is to control the passenger information system. During pre-flight, this includes the use of the safety belt, aircraft safety procedures and exit locations, as well as general aircraft information. During post-flight mode, airline gate arrival and departure information specific to that passenger is made available, as well as the capability to gather passenger preference information. In the present invention, the interactive information with the passenger (marketing data) is collected into the central control unit.

Yet another task of the general processor system is control of the menu and ordering system through which the passenger may order a drink, a meal, or the like, and communicate their selections directly to the flight attendant via a sub-unit of the central control unit. This sub-unit is a single display (LCD) with few controls.

A further task of the general processor system is monitoring the passenger in-seat indicator. Either infrared for body heat, ultraviolet, ultrasonic, heart or body microphone are all well known systems to indicate the presence of a human being. This information indicates to the flight attendant which seats of the aircraft are currently occupied.

Another task of the general processor system controls the passenger seat tray call button for passenger needs assistance. This is an integral part to the passenger seat tray and replaces the standard call button in aircraft today.

Yet another task of the general processor system is to allow the credit or debit card reader system to interact with the selection and purchasing system and the communications system. This allows the credit or debit card reader system to transfer information to the communication system. This in turn sends the billing information to the central control unit for later transfer to the appropriate credit or debit card bank or company.

Yet another task of the general processor system is to allow the interaction of the motion vibration and tilt system with the projection display system. This allows the monitoring of any disturbances that may occur during flight, and that for safety concerns, require the projection display system to be powered down and shut off.

The general processor system interacts with all other systems inclusive.

The invention herein contains a credit, debit or courtesy card reader and selection and purchasing system which are all well known in the art. Most notably, a magnetic strip along the credit, debit or courtesy card is swiped, and read, and user or passenger information is extracted. This method of card identification of the user of the card is well known. This user identification is then used to allow the purchase of videos or programs, games, internet usage, selection of food and drink menu items, or for the purchase of goods. The purchased selections or goods are then stored in the central control unit and uploaded into the airport or airline control system for debiting the passenger's credit or debit account upon landing. This upload into the appropriate system by use of a credit or debit card is well known in the bank credit or debit card transaction processing art.

The credit, debit or courtesy card reader and selection and purchasing system interacts with the general processor system, the video system, the audio system, the projection display system, the touch-tap pad system, and the selection and purchasing system.

The invention herein contains an audio system for music or speech which is well known in the art. Either headphones, a speaker, projected sound via a parabolic reflector, bone audio which vibrates human bones at audio frequencies, or ultrasonic audio projected into the human ear are all well known audio systems. All except the headphones would be an integral part of this invention. However, the headphone connector is also included as the airline may wish this type of audio system. Also, the passenger may wish to increase or decrease their volume setting which may be accomplished by the use of the touch-tap pads and the menu system.

An additional operation of the audio system is to communicate via the microphone of the passenger seat tray to the flight attendant via the sub-unit or galley unit. This is to communicate directly to the flight attendant any special needs of that particular passenger.

The audio system interacts with the general processor system, the video system, the touch-tap pad system, the selection and purchasing system, and the credit, debit or courtesy card reader and selection and purchasing system.

There are 2 preferred embodiments of the power supply system. One is the power supply system is contained within the passenger seat tray. The conversion of the aircraft incoming power to designated passenger seat tray power is well known in the art. Here, the passenger seat tray is used to distribute the heat of the power being used along the surface area of the passenger seat tray itself.

Another embodiment is the power system is internal to the strut holding the seat tray to the rear of the forward seat. This has the advantage that less heat is contained within the passenger seat tray and fewer components are required within the seat tray. The conversion from aircraft incoming power to designated passenger seat tray power is within the strut and not within the passenger seat tray. Overall heat within the passenger seat tray is minimized.

The power system interacts with all other systems inclusive.

The invention herein contains an rf and em shielded passenger seat tray. The passenger seat tray uses a metal shield encasing all electronics within the passenger seat tray. The use of a metal shroud for rf interference containment is well known in the art. Also, metal or carbon fibers embedded into plastic to contain rf fields could also be used and is well known in the art. Further, a mu-metal or the like em shielding metal may also be used to encase all electronics for em radiation shielding. The use of mu-metal or the like to absorb em radiation is well known in the art.

The invention herein contains a central control unit. This central control unit contains all game CD's, Video CD's, outside aircraft internet connection via airport internet cable or satellite reception, retention of passenger information and selections, menu download to individual passenger seat trays, and order and purchase information to be uploaded at the arrival airport to the respective airline system for later billing or credit card transaction processing. The uploading of this information to an airline operating system for billing or credit or debit card processing is well known in the banking art. The central control unit can be mounted within an overhead bin and is shock-reinforced to accommodate take off, landing and air turbulence. All systems of each passenger seat tray are enabled or disabled by the central control unit via the general processor system embodied within the passenger seat tray. The disable or enable of that specific system or parts thereof within the passenger seat tray is controlled by the central control unit. To facilitate safety, the central control unit is key-controlled by the specific airline of that aircraft. This control can be done remotely via an external Ethernet cable connected to the aircraft or via a wireless communication to the aircraft while on the ground. The chief flight attendant, with knowledge of the key, has the capability to override, disable, or enable, all systems or parts thereof of each passenger seat tray. This is to provide the capability of customizing the system with respect to passenger-age-related, religious or moral considerations in the use of internet or any specific system or component thereof. In this situation, individual parts of that system can be disabled. Furthermore, the central controller has the capability if sniping, which indirectly means to control the content of internet viewing or movies being transmitted from the central control unit to the passenger seat trays. The use of sniping to block or guard against certain content is well known in internet art. The central control unit has an Ethernet or wireless connection to the passenger seat trays as well as the galley or sub-unit (described below) to communicate with the passenger seat tray or galley unit. Last, the central control unit allows a single point for upgrading software and the like to all passenger seat trays and galley unit. By use of the key, and various access codes, an operator can upgrade or change all existent software not only within the central control unit, but also within the passenger seat trays and galley unit.

The invention herein contains a sub-unit or galley unit located within the galley(s) of the aircraft. This sub-unit is a small single touch-sensitive LCD indicating to the flight attendant meal or drink selection of individual passengers, passenger needs assistance, seat occupancy, seat location the attendant is communicating with, and the name of the person assigned to that seat. The sub-unit or galley unit can also establish a two-way communication with the passenger by use of the touch screen display and selection of the seat the attendant wishes to communicate with. The sub-unit or galley unit communicates directly to the central control unit via Ethernet or wireless.

### BRIEF DESCRIPTION OF DRAWINGS

FIG. 1 Passenger Seat Tray And Passenger Seat
1. Seat-Back of Forward seat
2. RF and EM Shielded Passenger Seat Tray
3. Passenger Seat Tray Release Lever
4. Strut
5. Power Cable
6. Ethernet Cable to Central Control

FIG. 2 Passenger Seat Tray Cut Away View
7. Power System
8. Power Connector
9. Power Cable
10. Power Supply Electronics In Seat tray
11. Power Supply Electronics In Strut
12. General Processor System
13. Memory
14. General Processor
15. Motion Vibration and Tilt System
16. Motion/Vibration, Sensor
17. Tilt Sensor
18. Card Reader System
19. Card Reader Electronics
20. Touch/Tap Pad System
21. Touch/Tap Pad Sensor
22. Touch/Tap Pad Sensor Electronics
23. Audio System
24. Audio Electronics
25. Communications System
26. Wireless Antenna
27. Wireless Electronics
28. Fiber Optic/Electrical Ethernet Cable Connector
29. Ethernet Electronics
30. Emergency Indicator Lamp Or LED
31. Talk Back Indicator Lamp or LED
32. Projection Display System
33. Laser Diode(s) or LED(s)
34. Digital Scanning Mirror Device
35. Screen Distance Sensor
36. Surrounding or Ambient Light Sensor
37. Forward Proximity Sensors
38. Projection Control Processor
39. Half-Mirror
40. Projection Lens
41. Reflected Wavelength Light Sensors
42. Reflected Light Intensity Sensors

FIG. 3 Passenger Seat Tray Edge View
43. Passenger-In-Seat Sensor
44. Card Reader Slot/Swipe
45. Head Phone Or Headset Jack
46. Directive Antenna For Directed Audio To Passenger
47. Microphone or In Seat Communicator.
48. Press-To-Talk Button
49. Passenger Seat Tray Call Button

FIG. 4 Central Control Unit Front Panel View
50. Central Control Unit
51. Touchpad LCD Display
52. CD Drive(s)
53. USB Port(s)
54. PCMIA, or other bus, Memory Card Port
55. Head Phone Or Headset Jack
56. Satellite Reception/Transmission Antenna System
57. Processing Electronics
58. Memory
59. Power System
60. Hard Drives

FIG. 5 Central Control Unit Rear Panel View
61. Central Control Unit
62. Cockpit Cable Connection
63. Wireless Antenna For Internal Cabin Communications
64. External Ethernet Connection
65. Satellite Reception/Transmission Outside Aircraft Antenna Connection
66. Internal Optical/Electrical Ethernet Cable Connection Port To Passenger Trays
67. Internal Optical/Electrical Ethernet Cable Connection Port to Sub/Galley Unit
68. Power Connection

FIG. 6 Sub or Galley Unit For Flight Attendant Viewing Communications
69. Sub or Galley Unit
70. Touch-Sensitive LCD Display
71. Assistance Needed Indicator Lamp Or LED
72. Emergency Indicator Lamp Or LED
73. Press-To-Talk Button
74. Speaker
75. Privacy Head Phone Or Headset Jack
76. Microphone
77. Ethernet Connection

FIG. 7 Example Of Projected Display
78. Projected Display On The Rear Of The Forward Seat
79. Light Beams Of The Projected Display

FIG. 8 Graphical Interface of the Passenger Convenience System

FIG. 9 Typical Flow Chart of The Operation of the Passenger Convenience System

### DETAILED DESCRIPTION OF THE PREFERRED EMBODIMENT

The figures and detail description of such are intended to fully explain the details of the preferred embodiment of the invention. However, this is not to say other embodiments of like formation would not be included within the scope of this description.

FIG. 1 depicts the passenger RF and EM shielded passenger seat tray (2), herein referred to as seat tray, is shown in its fully extended position when it is folded out from the rear of the forward seat (1). This is to show, that when the passenger seat tray (2) is folded out in this manner, the feasibility and practicality of the projection display system (32) to display an image (78) onto the rear of the forward seat (1).

FIG. 2 depicts the various systems (7), (12), (15), (18), (20), (23), (25), (32), herein referred to as systems, embodied within the seat tray (2). These systems and their respective operation will be described in detail herein.

The seat tray (2) must first recognize a passenger has been seated. The Passenger-in-Seat sensor (43) indicates a person is present within the seat behind the seat tray (2). Furthermore, the Passenger-in-seat sensor (43) indicates to the central control unit (50)(61) and to the sub-unit or galley unit (69), herein referred to as galley unit, that a passenger has taken his or her seat.

Depending on what portion of the flight is currently in progress, pre-flight, take-off, in-flight, landing, post-flight, herein called flight mode or mode, determines which system(s) will be powered on.

The captain, the co-pilot, the chief steward, flight attendant, or other airline personnel, herein referred to as operators, can determine when any flight mode begins operation. The mode of operation can also be automatically sensed via aircraft avionics. These determinations or time stamps of when each mode is in operation are pre-programmed via the central control unit (50)(61) or manually entered into the central control unit (50)(61) from any of the operators. The central control unit (50)(61) communicates this information to the seat tray (2) via the wireless antenna (26) or Ethernet cable (28) through the communications system (25). The seat tray (2) then acknowledges the mode from the general processor system (12) back to the central control unit (50)(61) via communications system (25). This two-way hand shake is necessary in order to verify the seat tray (2) is powered on, is operable, and provides acknowledgement of the mode the seat tray (2) is in.

It is to be understood, the central control unit (50)(61) via programming by an operator, determines the flight mode and hence the mode of the seat tray (2). This is to ensure what system(s) of the seat tray (2) are allowed to be operational during a particular mode. Also, during flight mode events, such as take off and landing, or during an exception event, such as an emergency, or when the seat is not in use, the seat tray (2) is powered down.

FIG. 2 further depicts tilt sensor (17) which indicates the seat tray (2) is being lowered from its stowed or locked position. Its final resting position is shown in FIG. 1. Upon the advent of the tilt sensor (17) indicating the seat tray (2) is in its lowered position, and dependent upon the current flight mode, the power system (7) begins its power-on sequencing.

The general processor system (12), the motion vibration and tilt system (15), and card reader system (18), audio system (23), communications system (25), and projection display system (32) is powered on. The touch-tap pad system (20) is made ready and put in standby mode. The touch-tap pad system (20) is not fully powered on until the passenger touches the touch-pad (21) and hence indicates the passenger wishes to use this system.

Also, the microphone (47), and press-to-talk button (48) will be powered on to allow the passenger to communicate to the flight attendant during any mode. Since there may be many passengers wishing to speak to the attendant at the same time, an audio talk back lamp (31) illuminates and thereby opens a voice channel to the flight attendant and thereby indicates to the passenger he or she may now communicate to the flight attendant.

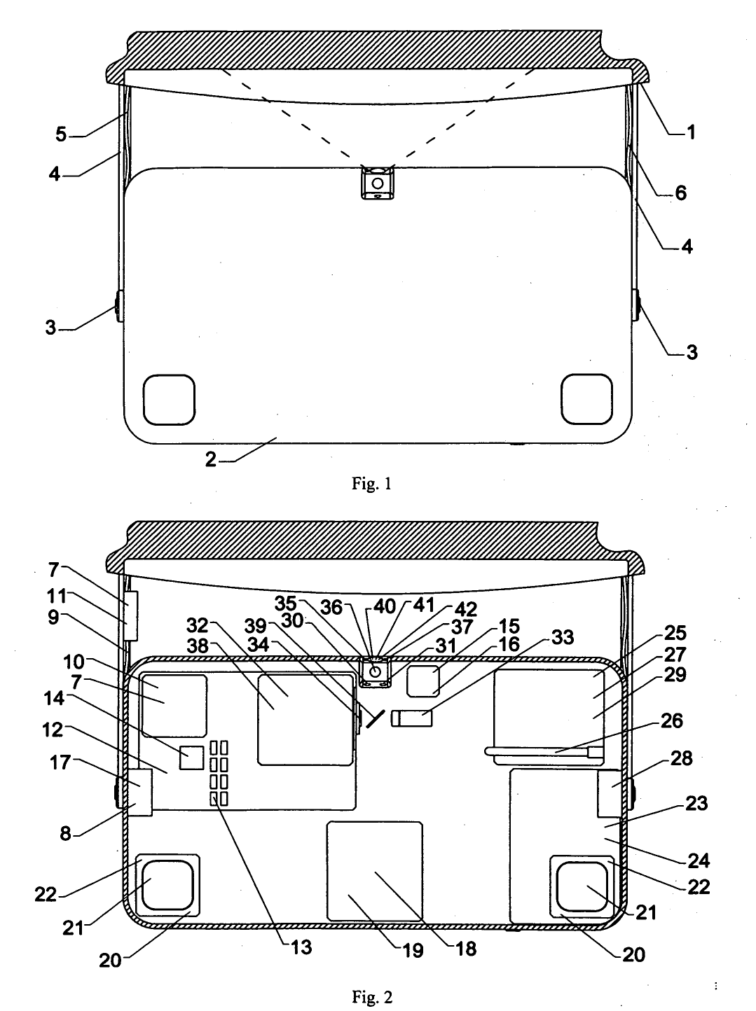

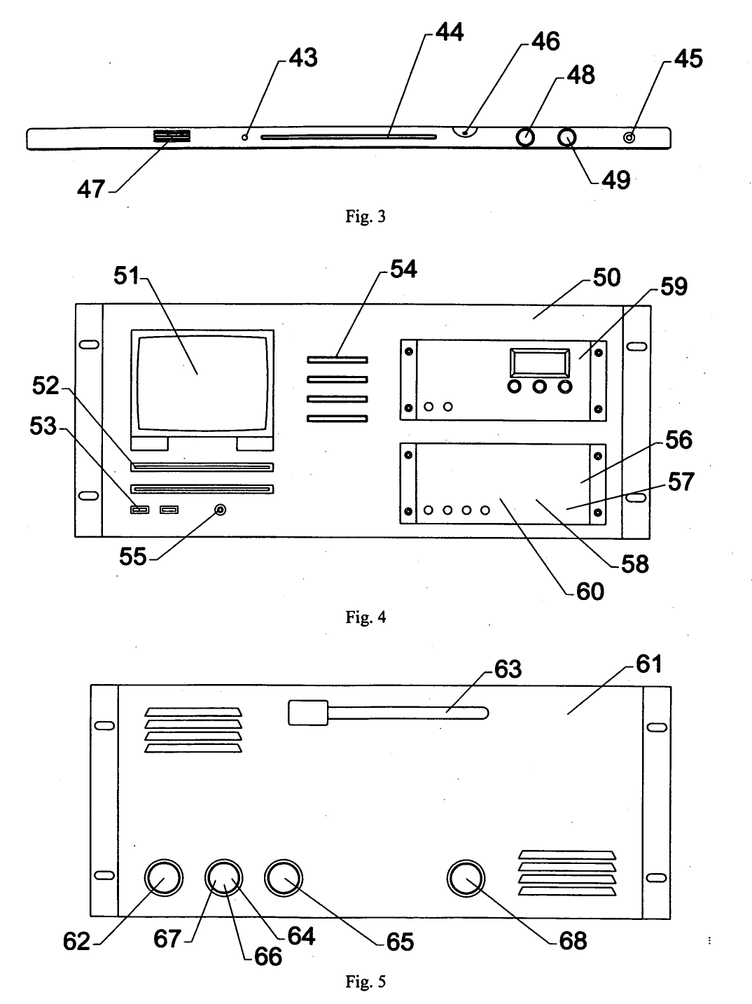

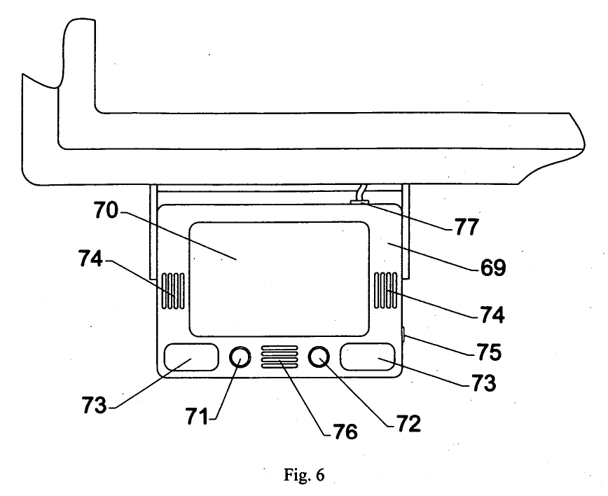

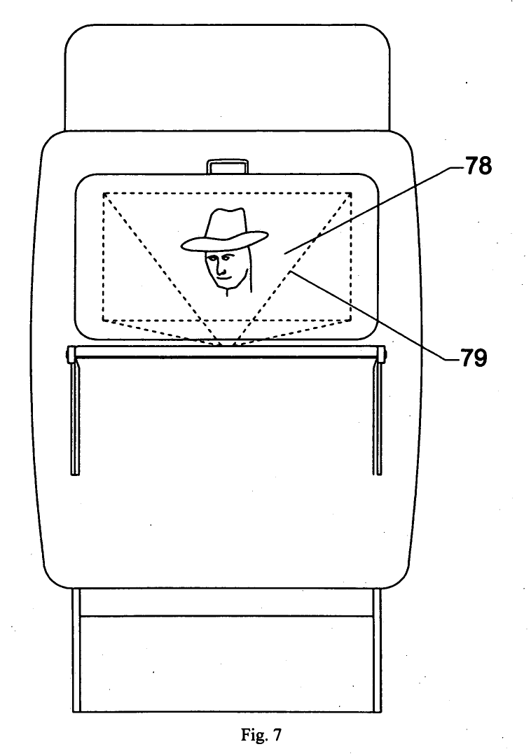

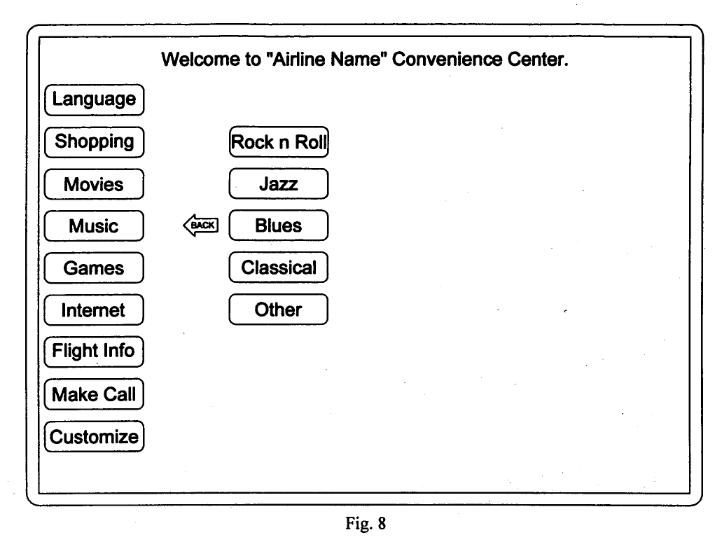

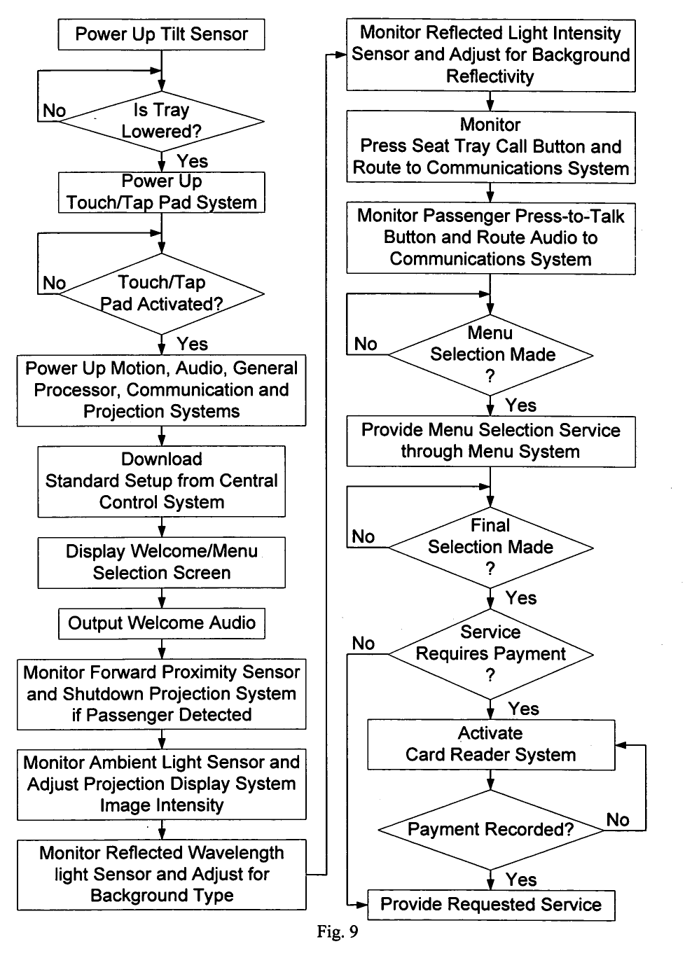

The projected display (78) now reveals a typical selection menu (FIG. 8). Here the passenger is allowed to make selections for games, movies, audio, internet, telephone, beverage or food selections, shopping and ordering, and purchasing via the touch-tap system (20). The touch-tap system (20) by means of cursor or arrow movement across the displayed image (78) selects the item or service, and via a touch-tap pad (21), indicates the acceptance of the item or service. In each selection, based on operator programming, the selection maybe free (courtesy card) or, if required, a credit or debit card purchase. If a fee is required, the card reader system (18) is provided. FIG. 9 depicts a flow chart for the selection and operation of the passenger seat tray (2) with respect to a passenger item selection or service.

The passenger will insert his or her credit or debit card into the credit or debit card slot (44) and hence by insertion and removal all card information of the passenger is acquired to make the purchase of the selected item or service.

The audio system (23) enables the passenger to hear, game, movie or music sound as required. The audio system (23) communicates these sound(s) to the passenger via head phone or headset jack (45) or directed acoustic antenna or bone phone (46). An acoustic antenna (46) is such that is directs audio sounds into the human ear by very narrow defined sonic beam. A bone phone is a method of vibrating human bones at an audio frequency by touching the passenger seat tray (2). This audio vibration is transmitted via the passenger's internal skeletal structure to the cochlea of the inner ear, and hence one hears sound based on this vibration. Directional acoustic antennas and bone phones are well known in the art.

In the event the passenger selects the telephone functionality, the display image (78) is that of a phone keypad, and the passenger, via touch-tap pad (21) selects the appropriate telephone number, which is then dialed. The passenger is allowed to make a phone call, with appropriate payment via the card reader system (18), through the central control unit (50,61), the audio system (23) and microphone (47) or headset inserted into headset jack (45) via the communications system (25).

The motion vibration and tilt system (15) indicates to the projection display system (32) the presence of any air turbulence which may be occurring during the viewing of the projected display (78). The motion vibration and tilt system (15) transmits to the projection display system (32) corrections to counter the motion or vibration of the aircraft, in order to ensure the display image (78) does not waffle or shake, making the display image (78) blurred or unable to be viewed.

Furthermore, the projection display system (32) uses a screen distance sensor (35) to ensure constant focus at varying passenger seat tray (2) distances to the rear of the forward seat (1). Since the angle of the light beam(s) impinging on the rear of the forward seat (1) may vary in distance and angle, the screen distance sensor (35) indicates to the projection display system (32) the modulation of the intensity of the light beam(s) (79) necessary for the portions of the displayed image (78), increasing the intensity for those farthest away, and decreasing the intensity of the light beam(s) (79) for those portions of the displayed image (78) nearest the passenger seat tray (2).

Furthermore, depending on the fabric color of the rear of the forward seat (78), reflected wavelength light sensors (41) determine what colors (wavelengths) of the projected image (78) are being reflected. These sensors (41) depict which light is being absorbed by the fabric and which are being reflected back to the passenger viewing the projected image (78). These reflections determine which color(s) should be enhanced, modified, intensified or the like to ensure an accurate color displayed image (78).

Furthermore, the projection display system (32) monitors an ambient light sensor (36) and reflected light intensity sensor (42) to ensure the projected image (78) luminescence is appropriate under all varying cabin light conditions.

The projection display system (32) also contains forward proximity sensors (37) in order to ensure no one is within near proximity of the light beam(s) of the projected display (78). The forward proximity sensors (37) indicate someone or something has come in close proximity to the light beam(s) (79). The forward proximity sensors (37) transmit this presence to the projection display system (32) and an immediate shut down of the projection display system (32) is initiated, turning off all light beam(s) (79).

In order for selection, ordering, purchasing and general information exchange, a task manager is employed. This task manager is the general processor system (12). The general processor system (12) determines who is doing what at what time. Furthermore, it transmits and communicates directly to the central control unit (50)(61) via the communications system (25). Also, it monitors operations of the passenger seat tray (2) and indicates any abnormality to the central control unit (50)(61) via the communications system (25).

The passenger seat tray (2) is attached to the forward seat (1) via seat struts (4). The passenger seat tray (2) is lowered into the user position by unlocking the stowed or locked position lever (3). During any mode the power to the passenger seat tray (2) is rendered to it by its power cable (5). The passenger seat tray (2) receives and transmits information to and from the central control unit (50)(61) via the wireless antenna (26) or Ethernet cable (6).

The power system (7) is connected to the passenger seat tray (2) by the power connector (8). The power system (7) in one embodiment is integral to the passenger seat tray (2) or in another embodiment with the seat strut (4) (11). The main power is transmitted to the passenger seat tray (2) via power cable (5)(9). The power system (7) converts the main power to passenger seat tray (2) designated power via the power electronics (10)(11). The conversion of this main power to seat tray power is well known in the art.

The general processor system (12) comprises memory (13), passenger-in-seat sensor (43) and the general processor (14). Task management, passenger selection and execution thereof, file system control, and processor execution via a general type processor are well known in the art.

The motion vibration and tilt system (15) is comprised of the motion vibration sensor (16) and tilt sensor (17). These sensors communicate directly to the projection display system (32) and general processor system (12). The motion vibration and tilt system (15) has been previously discussed herein.

The card reader system (18) is comprised of the card reader slot (44) and the card reader electronics (19). The use of the card reader system (18) has been previously discussed herein. The operation of a card reader system (18) is well known in the art.

The touch-tap pad system (20) is composed of the touch-tap pad sensor (21) and the touch-tap pad sensor electronics (22). The use and operation of touch-tap pad sensors (21) are well known in the art.

The audio system (23) includes an audio or headset jack (45) a directive antenna or bone phone (46) and audio electronics (24). The operation of the audio system (23) has been previously discussed herein. Audio system (23) and its operation are well known in the art.

The communications system (25) is composed of a wireless antenna (26), wireless electronics (27), fiber optic or electrical Ethernet connector (28), appropriate Ethernet electronics (29), microphone or in seat communicator (47), press-to-talk button (48), passenger seat tray call button (49) and emergency indicator lamp (30). The operation of the communications system has been previously discussed herein and the operation of wireless communication or Ethernet communication is well known in the art.

The projection display system (32), in the preferred embodiment, is a laser projector encompassing laser diodes (33), a DLP (34), a screen distance sensor (35), a surrounding or ambient light sensor (36), forward proximity sensors (37) and projection control electronics (38). In another embodiment the laser diode(s) (33) would be LEDs. In still another embodiment the laser diode(s) (33) would be a LCD through which light is projected to display an image. In still another embodiment the laser diode(s) (33) would be a light bulb. The operation of a laser, LED, LCD, or bulb projectors are well known in the art.

In the event the passenger tilts the passenger seat tray (2) or in the event the passenger-in-seat sensor (43) indicates passenger not in the seat, the seat tray (2) begins power down sequencing. This is to ensure minimum power during any time that the passenger is not viewing the projected image (78).

In the event a serious situation occurs, or a passenger needs immediate assistance, the passenger seat tray call button (49) may be used. Although the communications system (25) maybe powered down, the seat tray call button (49) and the emergency lamp (30) will remain powered through a power storage cell, either a battery or storage capacitor. The state of the seat tray call button (49) is transmitted to the central control unit (50)(61) and the galley unit (69) for immediate flight attendant attention. Once full power is restored to seat tray (2), the power storage cell is recharged in the event another such exception arises.

The central control unit (50)(61) comprises a LCD display (51) for viewing passenger information, requests, selections and the like. Also, the central control unit (50)(61) monitors the health and heartbeat of each passenger seat tray (2). Still further the central control unit (50)(61) comprised of the CD drives (52) for all non-internet downloaded games and movies, USB ports (53) for communications to USB type memory, PCMIA port (54), or other bus format slot, for insertion of different adaptors both present and future, cockpit cable connection (62) to allow pilot or copilot override of any existing pre-programmed central control unit (50)(61) programs or features, wireless antenna (63) for communication via wireless means to the passenger seat tray(s) (2), head phone jack (55) for listening to any program, game, movie or music, being played, external Ethernet connection (64) for external outside aircraft connection for information uploads and downloads, satellite antenna connection (65) for the reception and transmission of satellite signals via an external outside aircraft satellite antenna, satellite antenna reception system (56) to process the received or transmitted satellite signal information, internal Ethernet cable connection port (64) for Ethernet cable connection to allow transmission and reception of information from all passenger seat trays (2), internal Ethernet cable connection port (64) for Ethernet cable connection allowing transmission and reception of information from the sub-galley unit (69), processing electronics (57) for task and control management to the central control unit (50)(61), memory (58) for the temporary retention of passenger information as well as internal control program storage and execution, a hard drive(s) (60) for permanent record storage of the passenger information as well as permanent retention of control programs, a power connection (68) for incoming power to be converted for operation of the central control unit (50)(61), and the power system (59) to convert the main power to the designated power of the central control unit (50)(61). All these components are integral to the central control unit (50)(61) and though many, each individual component is well known in the art.

The central control unit (50)(61) controls the operation of modes, passenger seat trays (2), communications external to the aircraft, communications to passenger seat trays (2) internal to the aircraft, information storage and retrieval, as well as houses the games, the movies, or the internet link for use by the passenger seat trays (2).

The central control unit (50)(61) has the ability, via operator control, to override any preprogrammed feature or operation of any passenger seat tray (2). An example of this would be to offer a free movie, where normally this would be a purchased selection, perhaps due to a delayed takeoff.

The galley unit (69) is a display and indicator console for the flight attendant to determine if a passenger is seated, needs assistance, to be alerted to an exception or event, to indicate passenger seat tray stowed and locked for take-off and landing or to directly communicate with the passenger. The galley unit (69) comprises a LCD display (70), assistance-needed indicator lamp (71) to alert the attention of the flight attendant(s), emergency indicator lamp (72) to indicate an emergency or serious event, a microphone (76) and a press-to-talk button (73) to allow direct communication with the passenger, a speaker (74) or head phone jack (75) for the use of head phones. The use of LCD (70), lamps (71)(72), press-to-talk (73), speaker (74) and the like are well known in the art.

Furthermore the galley unit (69) contains an Ethernet connection (77) for communication back to the central control unit (50)(61). The use of the Ethernet connection (77) has been previously discussed and is well known in the art.

What is claimed is:

1. An integrated electronic convenience system integral within a passenger seat tray of an aircraft passenger seat comprising;
(a) struts from the rear of the forward seat or as a foldout from the arm rest of the passenger seat therein;
(b) a rf or em shield such that it eliminates the transmission of rf and em energy from said seat tray;
(c) a power connector to power said seat tray;
(d) an Ethernet connector embodied within said seat tray to attach to an Ethernet cable or a wireless antenna which communicates to a central control unit;
(e) an electronic power system to reduce the main aircraft power to said seat tray designated power;
(f) a general processor electronic system for control of all other internal systems, task management, and passenger selection display menu and communication thereof embodied within said seat tray through the communications system of said seat tray to a central control unit;
(g) a communications system embodied within said seat tray to allow electronic Ethernet communications to and from a central control unit;
(f) a touch-tap pad system embodied within said seat tray for use as the passenger menu selection and game playing medium;
(g) an audio system embodied within said seat tray to allow the passenger to hear the passenger selection thereof and/or speak to the flight attendant or to convert voice into normal telephone communications;
(h) a projection display system embodied within said seat tray to display upon the rear of: the forward seat a menu, food and drink, video, game, items to purchase, telephone talk time, internet, airline and general information image with a constant luminance, focus, correct color, and safety by use of distance, ambient light, reflected color, and proximity sensors;
(i) a motion vibration and tilt system embodied within said seat tray to ensure throughout any motion or vibration condition the displayed image is held fixed and motionless and to indicate a stowed or unlocked position and a fully extended or level position of said seat tray;
(j) a card reader system embodied within said seat tray to allow the passenger to purchase items or services selected by credit, debit or courtesy card;
(k) a passenger-in-seat indicator embodied within said seat tray;
(l) a flight attendant call button embodied within said seat tray;
(m) a press-to-talk button embodied within said seat tray;
(n) a talk back indicator lamp embodied within said seat tray;
(o) an emergency lamp indicator embodied within said seat tray;
whereby said convenience system integral with the passenger seat tray can project an image onto the rear of the forward seat, make selections via scrolling arrow of the touch-tap system, pay for those selections via a card reader system, to provide to the passenger visual, audio, shopping, internet, or telephone entertainment while increasing revenue for the operator of the aircraft containing the convenience system and information by use of passenger-in-seat indicator and post-flight marketing questionnaires;

2. An integrated electronic convenience system integral within a passenger seat tray of claim 1 in the preferred embodiment said power system is within the seat tray.

3. An integrated electronic convenience system integral within a passenger seat tray of claim 1 in another embodiment said power system is within the seat tray strut.

4. An integrated electronic convenience system integral within a passenger seat tray of claim 1 in the preferred embodiment the rf and em shield is of metal shavings or the like embedded within the plastic or material of the seat tray.

5. An integrated electronic convenience system integral within a passenger seat tray of claim 1 in another embodiment the rf and em shield is a metal shroud contained within the seat tray.

6. An integrated electronic convenience system integral within a passenger seat tray of claim 1 in the preferred embodiment the Ethernet connector is for an optical Ethernet connection.

7. An integrated electronic convenience system integral within a passenger seat tray of claim 1 in the preferred embodiment the Ethernet connector is for an electrical Ethernet connection.

8. An integrated electronic convenience system integral within a passenger seat tray of claim 1 in the preferred embodiment the communications system receives and transmits communication electrical signals via the Ethernet connector.

9. An integrated electronic convenience system integral within a passenger seat tray of claim 1 in another embodiment the communications system receives and transmits communication electrical signals via wireless antenna.

10. An integrated electronic convenience system integral within a passenger seat tray of claim 1 in the preferred embodiment the audio system transmits audio information to the passenger via a headphone.

11. An integrated electronic convenience system integral within a passenger seat tray of claim 1 in another embodiment the audio system transmits audio information to the passenger via an acoustic transmitter directive antenna.

12. An integrated electronic convenience system integral within a passenger seat tray of claim 1 in another embodiment the audio system transmits audio information to the passenger via a bone phone.

13. An integrated electronic convenience system integral within a passenger seat tray of claim 1 in the preferred embodiment the audio system receives voice information from the passenger via a microphone embedded within or at the edge of the seat tray.

14. An integrated electronic convenience system integral within a passenger seat tray of claim 1 in the preferred embodiment the projection system is a laser projector.

15. An integrated electronic convenience system integral within a passenger seat tray of claim 1 in another embodiment the projection system is a LED projector.

16. An integrated electronic convenience system integral within a passenger seat tray of claim 1 in another embodiment the projection system is a LCD projector.

17. A central control unit comprising;
(a) a touch-sensitive LCD display for operator programming, override, diagnostic query and passenger in-seat indication, passenger seat tray being used, and which selection the passenger has made or is making;
(b) a plurality of read only CD Drives for movies, games, music, and operator information;
(c) a single write CD Drive for collection and storage of passenger information and selections;
(d) a plurality of USB ports for upload of operator programs and information or download of passenger information and selections;
(e) a cockpit or avionics connector for connection into cockpit electronics;
(f) an Ethernet cable connector for in-cabin communications to and from individual passenger seat trays;
(g) a wireless antenna for in-cabin communications to and from individual passenger seat trays;
(h) a head phone or headset jack for diagnostic listening to various CDs or communications to a specific passenger;
(i) an external Ethernet connection for operator program and information downloads, program query, and passenger telephone communication during pre-flight;
(j) a satellite transmission and reception system for all mode communications with a ground operator or satellite operating system of music, video, games, or TV;
(k) an Ethernet connector for communications to the galley unit;
(l) a multi-gigabyte hard drive for retaining execution programming, operator information, passenger criteria, aircraft information and temporary storage of passenger selections, purchases, and post-flight questionnaires;
(m) multi-gigabyte memory for operator program execution;
(n) a power connector for connection to onboard aircraft main power;
(o) a power system for converting aircraft main power to designated power;
whereby the central control unit via aircraft mode and operator determines what systems, and passenger selections are operable within the passenger seat tray, what items or selections maybe purchased or are free of charge, receives program upgrades and specific passenger information from the operator's general system, downloads any new operational and executable programs to the passenger seat tray, and collects passenger information and selections for later uploading into the operator's general system via Ethernet, satellite, or wireless communication.

18. A sub or galley unit comprising;
(a) a touch-sensitive LCD display for passenger-in-seat indication, passenger needs assistance indication, passenger emergency indication, and passenger communication indication;
(b) a general emergency indicator lamp indicating the aircraft is in an emergency state;
(c) a press-to-talk button for two-way communication to a selective passenger;
(d) a speaker for general comments to flight crew from another member of the flight crew;
(e) a head phone or headset jack for privacy communication between a selected passenger or member of the flight crew
(f) an Ethernet connector, electrical or optical, providing connection to an Ethernet cable to the central control unit;
whereby the sub or galley unit communicates directly to the central control unit providing indications to the sub or galley unit passenger presence in seat, which passenger is being communicated to, if a crew member is being communicated to, which passenger needs assistance, which passenger is in an emergency situation, if the aircraft is in an emergency situation, and to be used as the two-way communication device for the selected passenger or a member of the flight crew.
